(19) United States
(12) Patent Application Publication
(10) Pub. No.: US 2026/0238746 A1
(43) Pub. Date: Aug. 13, 2026

(54) SYSTEMS AND METHODS FOR CALIBRATING A CAMERA COORDINATE SYSTEM TO A SURFACE COORDINATE SYSTEM

(71) Applicant: Universal City Studios LLC, Universal City, CA (US)

(72) Inventor: Sarah La Forge, Titusville, FL (US)

(21) Appl. No.: 19/530,002

(22) Filed: Feb. 4, 2026

Related U.S. Application Data
(60) Provisional application No. 63/755,390, filed on Feb. 7, 2025.

(51) Int. Cl. H04N 9/31; G06T 7/80

(52) U.S. Cl. CPC H04N 9/3185; G06T 7/80; H04N 9/3173; H04N 9/3194; G06T 2207/30208; H04N 9/3182

(57) ABSTRACT

A system includes a reference marker, a camera configured to provide a signal indicative of a position of the reference marker, a surface, and a controller having a memory and a processor. The controller determines a camera intrinsics matrix based on one or more properties associated with the camera. The controller also determines a first transformation matrix indicative of a first spatial transformation from the camera to a calibration board. The controller also determines a second transformation matrix indicative of a second spatial transformation from the calibration board to the surface. The controller also determines a mapping matrix based on the camera intrinsics matrix, the first transformation matrix, the second transformation matrix, or a combination thereof. The controller also defines an alignment of a handheld device comprising the reference marker with the surface based on the mapping matrix.

### CROSS-REFERENCE TO RELATED APPLICATION

This application claims priority to and the benefit of U.S. Provisional Application No. 63/755,390, entitled “SYSTEMS AND METHODS FOR CALIBRATING A CAMERA COORDINATE SYSTEM TO A SURFACE COORDINATE SYSTEM,” filed Feb. 7, 2025, which is incorporated by reference herein in its entirety for all purposes.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Systems and methods for detecting positioning and/or movement of an object are useful for many purposes. For example, detected movement of a handheld object may be used to control special effects in a theme park setting. As a specific example, guests (e.g., theme park guests) may be entertained by activating or otherwise controlling the special effects based on their own controlled movement of the handheld object, which may facilitate game-based interactions and/or immersive experiences. There are also many other uses for detecting positioning and/or movement of handheld objects. ‘However, it is now recognized that there is a need for improvements to traditional systems and methods related to detecting positioning and/or movement of an object.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system includes a reference marker, a camera configured to provide a signal indicative of a position of the reference marker, a surface, and a controller having a memory and a processor. The controller determines a camera intrinsics matrix based on one or more properties associated with the camera. The controller also determines a first transformation matrix indicative of a first spatial transformation from the camera to a calibration board. The controller also determines a second transformation matrix indicative of a second spatial transformation from the calibration board to the surface. The controller also determines a mapping matrix based on the camera intrinsics matrix, the first transformation matrix, the second transformation matrix, or a combination thereof. The controller also defines an alignment of a handheld device comprising the reference marker with the surface based on the mapping matrix.

In an embodiment, a method includes determining, via a processor, a location of a reference marker with respect to a camera based on a signal received from the camera. The method also includes determining, via the processor, a camera intrinsic matrix based on one or more properties associated with the camera. The method also includes determining, via the processor, a first transformation matrix indicative of a first spatial transformation from the camera to a calibration board. The method also includes determining, via the processor, a second transformation matrix indicative of a second spatial transformation from the calibration board to a surface. The method also includes determining, via the processor, a mapping matrix based on the camera intrinsics matrix, the first transformation matrix, the second transformation matrix, or a combination thereof. The method also includes defining, via the processor, an alignment of a handheld device comprising the reference marker with the surface based on the mapping matrix.

In an embodiment, one or more tangible, non-transitory, computer-readable media, include instructions stored thereon that, when executed by at least one processor, cause the at least one processor to determine a camera intrinsics matrix based on one or more properties associated with a camera. The instructions also cause the at least one processor to determine a first transformation matrix indicative of a first spatial transformation from the camera to a calibration board. The instructions also cause the at least one processor to determine a second transformation matrix indicative of a second spatial transformation from the calibration board to a surface. The instructions also cause the at least one processor to determine a mapping matrix based on the camera intrinsics matrix, the first transformation matrix, the second transformation matrix, or a combination thereof. The instructions also cause the at least one processor to define an alignment of a handheld device comprising the reference marker with the surface based on the mapping matrix.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an attraction system including a calibration system, according to embodiments of the present disclosure;

FIG. 2 is a schematic perspective view of the calibration system of FIG. 1, according to an embodiment of the present disclosure;

FIG. 3 is a schematic perspective view of a light detection and ranging (LiDAR) sensor of the calibration system of FIG. 1 collecting data, according to embodiments of the present disclosure;

FIG. 4 is a schematic perspective view of a plurality of fitted geometries determined by the calibration system of FIG. 1 based on the data received from the LiDAR sensor, according to embodiments of the present disclosure;

FIG. 5 is a schematic perspective view of a user using the attraction system after calibration via the calibration system of FIG. 1 according to embodiments of the present disclosure; and

FIG. 6 is a flow diagram of an example process performed by the calibration system of FIG. 1, according to embodiments of the present disclosure.

### DETAILED DESCRIPTION

The present disclosure relates generally to handheld object detection and, more particularly, to a system and method for calibrating a coordinate system of a camera that detects the handheld object with respect to a coordinate system of a surface at which the handheld object is pointed.

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to systems and methods for detecting positioning and/or orientation of handheld objects used for pointing and, more particularly, to determining a projected target location of a handheld object. In accordance with present embodiments, a reference element is attached to the handheld object and is observed and analyzed in accordance with present embodiments to provide a two-dimensional (“2D”) coordinate location for use in identifying a position and/or orientation of the handheld object relative to a target (e.g., portions of a display). In particular, the reference element may provide an indication to a camera (e.g., stereo camera, depth camera, 2D camera), which may also be referred to as an image sensor, as to where a handheld object is aligned relative to a target (e.g., an imaginary plane corresponding to a scene, display, or surface). For example, in the setting of a theme park, a user may point the handheld object at an interactive element, such as an animated object (e.g., a robot or otherwise animated figure) of an attraction. In response to detecting the location of the reference element and the corresponding projected target location with which the handheld object is aligned, the interactive element may be appropriately activated. For example, the animated object may output a user interaction experience (e.g., wagging a tail) based on the system determining that the handheld object is aligned with and essentially pointing at the animated object or some other activation target. As another example, the user may align the handheld object with a word on a poster, and, in response to detecting this orientation of the handheld object based on a determined location of the reference element relative to the surface, a nearby speaker may output a voice speaking the word. As yet another example, the user may point to an image of a person on an electronic display with the handheld object, and, in response to detecting this orientation of the handheld object (based on determining the location of the reference element), the display may play a video showing the person in the image moving.

The presently disclosed systems and methods may be used with an attraction system that enables a user to point a hand-held object (e.g., a wand) at an area and provide visual feedback to the user regarding one or more images displayed in the area based on a location of the wand. The visual feedback may provide the user with a sense that they are controlling one or more aspects of the area based on manipulation (e.g., movement) of the wand. In an embodiment, the attraction system includes a two-dimensional surface (e.g., a window, plane). The attraction system includes a camera and an output device (e.g., projector) that are communicatively coupled to a controller having memory (e.g., one or more memories) and a processor system (e.g., one or more processors). The camera outputs a two-dimensional coordinate (e.g., relative to a reference frame of the camera) of a location of a reference element attached to the handheld object. The output device projects an image onto the surface. The controller may receive data from the camera indicative of the handheld object relative to the camera. The controller may transform the location of the handheld object as being with respect to the camera to being with respect to the two-dimensional surface. As discussed herein, in an embodiment, the controller may alter the image based on the location of the handheld object with respect to the two-dimensional surface based on the data (e.g., two-dimensional coordinate) received from the camera.

The calibration system used for calibration of the attraction system discussed above includes a calibration board and a light detection and ranging (LiDAR) sensor. The calibration board may be positioned in front of the camera in a general vicinity of where the reference element may be located during operation of the attraction system. For example, an interactive attraction may include the camera directed to a guest space in front of an interactive display so that the camera can detect a handheld object (including the reference element) intended to activate the display, and the calibration board may be positioned in the guest space where such handheld objects may be used. The controller determines a first transformation matrix indicative of a pose of the calibration board relative to the camera based on four or more correspondences (e.g., markers, reference points) between the calibration board and the camera. The calibration system then determines a transformation matrix between the calibration board and the surface based on data (e.g., three-dimensional (“3D”) data, point clouds) provided by the LiDAR sensor of the environment. In response to scanning the environment, the LiDAR sensor sends a plurality of points (e.g., a point cloud) to the controller. The controller may extract a first point cloud (e.g., via segmentation) indicative of the calibration board and a second point cloud indicative of the surface. The controller may fit a first plane to the first point cloud and a second plane to the second point cloud. For example, the controller may use a least-squares (e.g., regression) algorithm to fit the first plane to the first point cloud associated with the calibration board, and to additionally fit the second plane to the second point cloud associated with the surface. The controller may determine a second transformation matrix indicative of a pose of the surface relative to the calibration board based on the first and second fitted planes. For example, the controller may determine the pose of the surface relative to the calibration board by determining the difference in Euclidean coordinates and orientation between the first and second planes.

The controller may determine a mapping matrix that maps coordinates (e.g., two-dimensional coordinates) output by the camera to a coordinate system of the surface. In an embodiment, the surface coordinate system may include an origin located at a centroid of the surface. As discussed in further detail herein, the mapping matrix may be determined based on a camera intrinsic matrix, the first transformation matrix, the second transformation matrix, a rendering matrix, or a combination thereof. In an embodiment, the controller may determine a position (e.g., location) of the reference element relative to the surface coordinate system based on a signal received from the camera indicative of a location of the reference element in camera coordinates, as well as the determined mapping matrix. That is, the controller may map a location of a reference element in camera coordinates to a location on the surface in surface coordinates using the determined mapping matrix. In an embodiment, the controller may control an output device (e.g., a projector) to project an image onto the surface. In response to the determined position of the reference element intersecting the image projected onto the surface, the controller may instruct the output device to alter an appearance (e.g., shape, size, color) of the image. For example, in response to the determined position intersecting the image, the controller may instruct the output device to highlight the image, thereby giving a user holding the handheld object (e.g. with the reference element) that they are controlling one or more aspects of the projected image based on their manipulation (e.g., movement) of the handheld object.

In an embodiment, the attraction system may include an object disposed behind (e.g., or in front of) the surface. In addition to the point clouds associated with the calibration board and the surface, the controller may determine (e.g., segment) a third point cloud indicative of the object based on the data received from the LiDAR sensor. The controller may determine a third transformation matrix indicative of a pose of the object relative to the surface based on fitting a three-dimensional model of the object to the third point cloud. As discussed in further detail herein, in an embodiment, the controller may determine the mapping matrix based on a camera intrinsic matrix, the first transformation matrix, the second transformation matrix, the third transformation matrix, a rendering matrix, or a combination thereof. The controller may map a point in camera coordinates (e.g., a reference frame of the camera) to a point in a coordinate system associated with the object (e.g., a reference frame of the object). That is, the controller may map a location of a reference element in camera coordinates to a location on the object in a coordinate system associated with the object using the determined mapping matrix along with a non-linear transform (e.g., non-linear function). In an embodiment, the controller may map the point in camera coordinates to multiple three-dimensional objects.

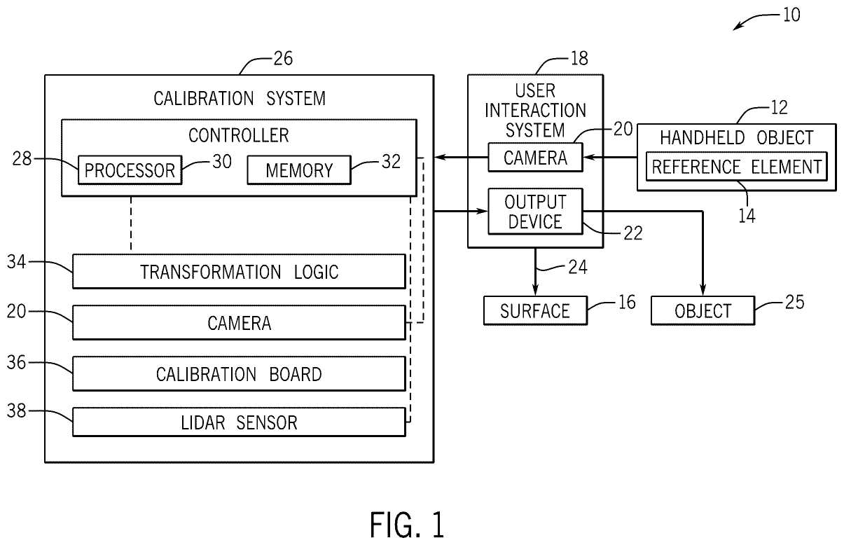

Turning to the figures, FIG. 1 is a block diagram of an attraction system 10, according to embodiments of the present disclosure. The attraction system 10 may include a handheld object 12 with a reference element 14 (e.g., a reflective tip), as held and manipulated by a user. The attraction system 10 also includes a two-dimensional surface 16 (e.g., two-dimensional plane, wall, window, etc.) in a view of the user. The term “two-dimensional” should not be interpreted in a rigid mathematical sense. Rather, in the present disclosure, the term “two-dimensional” refers to a generally flat or planar surface that may include irregularities. Indeed, in accordance with the present disclosure, a two-dimensional surface may be formed by a smoke screen, sheetrock, a waterfall, posterboard, a window, or the like. The attraction system 10 may also include a user interaction system 18, which includes a camera 20 that detects a location of the reference element 14 (e.g., a reference marker, wand tip). In an embodiment, the reference element 14 may include a material (e.g., retroreflective material) that is more easily detected by the camera 20. Additionally or alternatively, the reference element 14 may emit a signal (e.g., infrared signal, beam) that may be detected by the camera 20. The camera 20 may output a signal indicative of the location of the reference element 14. In an embodiment, the signal output by the camera 20 may include two or more coordinates. The user interaction system 18 also includes an output device 22 (e.g., projector) that outputs (e.g., projects) an image 24 onto the two-dimensional surface 16. In an embodiment, the two-dimensional surface 16 may be a non-solid boundary (e.g., a layer of mist, a layer of fog). Additionally or alternatively, the output device 22 may output the image 24 onto an object 25 (e.g., 3D object), such as a stationary object and/or a moving object (e.g., an animated figure).

The attraction system 10 may further include a calibration system 26, which calibrates the camera coordinates of the reference element 14 detected by the camera to the two-dimensional surface 16. The calibration system 26 may include a controller 28, having one or more processors (illustrated as processor 30) and one or more memory or storage devices (illustrated as memory device 32). The processor 30 may execute software programs and/or instructions stored in the memory device 32 that facilitate determining the projected target location of the handheld object 12. Moreover, the processor 30 may include multiple microprocessors, one or more “general-purpose” microprocessors, one or more special-purpose microprocessors, and/or one or more application specific integrated circuits (ASICS). For example, the processor 30 may include one or more reduced instruction set (RISC) processors. The memory device 32 may store information such as control software, look up tables, configuration data, and so forth. The memory device 32 may include a tangible, non-transitory, machine-readable-medium, such as volatile memory (e.g., a random access memory (RAM)), nonvolatile memory (e.g., a read-only memory (ROM)), flash memory, one or more hard drives, and/or any other suitable optical, magnetic, or solid-state storage medium. The memory device 32 may store a variety of information and may be used for various purposes, such as instructions that facilitate the projected target location of the handheld object 12.

The calibration system 26 may further include transformation logic 34 that transforms the location of the reference element 14, as detected by the camera 20, into a projected target location with respect to the two-dimensional surface 16 (e.g., glass-paned window). In particular, the transformation logic 34 may determine a mapping matrix from the two-dimensional camera coordinate output by the camera 20 to a two-dimensional coordinate specifying the location of the image 24 projected (e.g., by the output device 22) onto the two-dimensional surface 16. As shown, the camera 20 and the output device 22 are communicatively coupled to the controller 28. The calibration system 26 also includes a calibration board 36 and a light detection and ranging (LiDAR) sensor 38, as discussed in further detail herein.

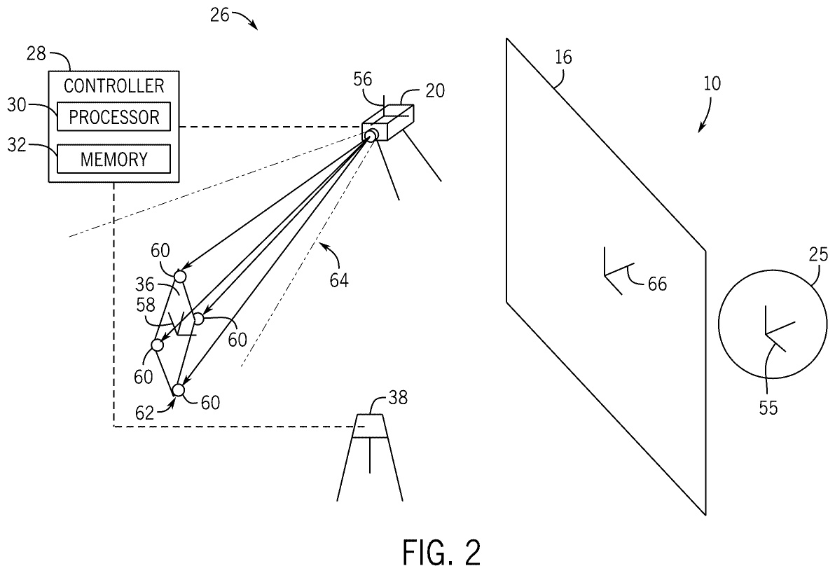

FIG. 2 is a diagram of the calibration system 26 of FIG. 1. In the illustrated embodiment, the calibration system 26 includes the camera 20, the calibration board 36, and the LiDAR sensor 38. As shown, the calibration system 26 is disposed in a vicinity of the attraction system 10, which includes the two-dimensional surface 16. In an embodiment, the attraction system 10 may include the object 25 (e.g., a dynamic prop that performs special effect) having an object reference frame 55 disposed behind the two-dimensional surface 16. As shown, the camera 20 is communicatively coupled to the controller 28.

As described herein, the controller 28 may execute the transformation logic 34 via the processor 30 to calibrate the coordinates (e.g., two-dimensional camera coordinates) output by the camera 20 to coordinates that describe a location on the two-dimensional surface 16. The transformation logic 34 may first determine a camera intrinsic matrix (K_{c}) based on one or more properties of the camera 20. In an embodiment, the camera intrinsic matrix may be based at least on a focal length (fₓ,f_{y}) of the camera, an offset (x₀,y₀) of the principal point of the camera, and/or an axis skew(s) of the camera. For example, the intrinsic matrix may take the following form:

$${K}_{c} = [ \begin{matrix}{f}_{x} & s & {x}_{0} \\ 0 & {f}_{y} & {y}_{0} \\ 0 & 0 & 1\end{matrix} ]$$

The camera intrinsic matrix may convert the homogenous coordinates of a point with respect to a camera reference frame 56 of the camera 20 to homogenous coordinates of the point in an image (e.g., associated with the camera).

$${p}^{′} = {K}_{c} {P}_{c}$$

$${P}_{c} = [ \begin{matrix}x \\ y \\ z\end{matrix} ]$$

$${p}^{′} = [ \begin{matrix}u \\ v \\ 1\end{matrix} ]$$

In the above equations, x, y, and z are the world coordinates with respect to the camera reference frame 56, and u and v are the image coordinates. The controller 28 may also determine a first transformation matrix indicative of a first spatial (e.g., affine) transformation from the camera reference frame 56 to a calibration board reference frame 58 of the calibration board 36. As shown, the calibration board 36 is positioned in a general vicinity where the reference marker 14 described in FIG. 1 will be detected. That is, the calibration board 36 is positioned within the field of view 64 of the camera 20. The calibration board 36 includes four or more correspondences 60. As shown, the correspondences 60 are located at each corner 62 of the calibration board 36. In an embodiment, the correspondences 60 are located elsewhere on the calibration board 36.

In an embodiment, the controller 28 may detect four or more correspondences 60 on (e.g., coupled to) the calibration board 36 while the calibration board 36 is held stationary at a particular pose. In an embodiment, the correspondences 60 may correspond to (e.g., have an appearance like) the reference element 14 described in FIG. 1. For example, the correspondences 60 may include retroreflective tips attached to the calibration board 36. In an embodiment, the calibration board 36 may be a checkerboard, and the correspondences 60 may be corners of one or more squares of the checkerboard. In an embodiment, the controller 28 may detect the correspondences 60 based on a feature recognition (e.g., machine learning) algorithm. In an embodiment, more than four correspondences 60 may be used. For example, 5, 6, 7, 8, or more correspondences 60 may be detected by the camera 20. Additionally or alternatively, the calibration board 36 may be held at more than one pose to increase an accuracy of the pose estimation of the calibration board 36 relative to the camera 20. In an embodiment, the camera 20 is an infrared (IR) camera that operates at a frequency of 60 hertz (Hz). Additionally or alternatively, the camera 20 may operate at a frequency different from 60 Hz.

Given the world coordinates of the four or more correspondences 60 and corresponding image coordinates, the controller 28 may implement a direct linear transform to solve for a first transformation matrix (T_{b,c}) indicative of a spatial (e.g., affine) transformation from the camera 20 to the calibration board 36. That is, the first transformation matrix may be indicative of a pose of the calibration board 36 relative to the camera 20. The first transformation matrix may take the following form, where R_{b,c} is a rotation matrix indicative of an orientation of the calibration board 36 relative to the camera 20 and t_{p,c} is indicative of a translation (e.g., position) of the calibration board 36 relative to the camera 20:

$${T}_{b , c} = [ \begin{matrix}{R}_{b , c} & {t}_{b , c} \\ 0 & 1\end{matrix} ]$$

In the illustrated embodiment, the two-dimensional surface 16 is outside of the field of view 64 of the camera 20. It may be appreciated that by transforming a location of the reference marker from the camera reference frame 56 to a surface reference frame 66 of the two-dimensional surface 16, the camera 20 may be located away from the two-dimensional surface 16 to keep the camera 20 hidden from a guest of the attraction system.

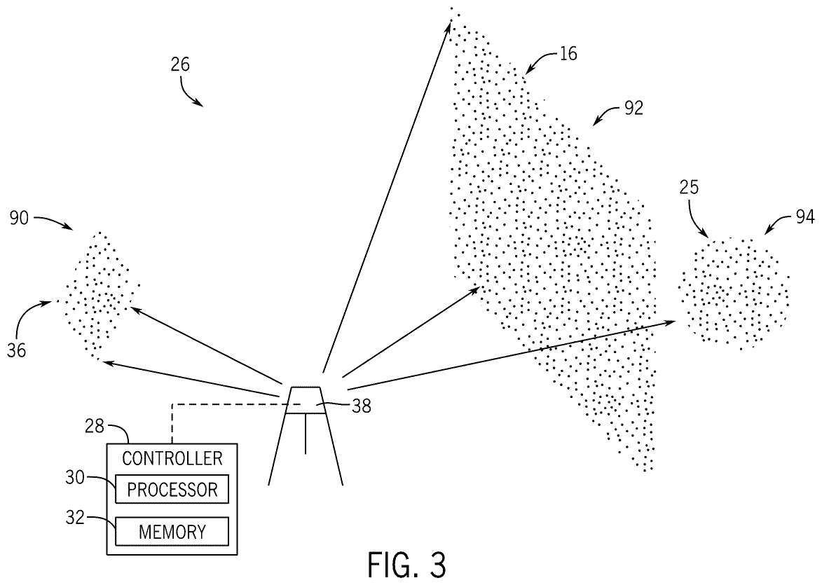

FIG. 3 is a diagram of the LiDAR sensor 38 of the calibration system 26 of FIG. 1 collecting data associated with the attraction system 10. In the illustrated embodiment, the LiDAR sensor 38 is communicatively coupled to the controller 28. In certain embodiments, the LiDAR sensor 38 may include a scanning LiDAR sensor, a solid-state LiDAR sensor, a flash LiDAR sensor, or a combination thereof. As shown, the LiDAR sensor 38 may collect data associated with the calibration board 36 and the two-dimensional surface 16. In an embodiment, the LiDAR sensor 38 may also collect data associated with the object 25.

In an embodiment, the data collected by the LiDAR sensor 38 is a plurality of three-dimensional homogeneous points (e.g., a point cloud) relative to the LiDAR sensor 38. The controller 28 may perform one or more segmentation algorithms (e.g., singular value decomposition, thresholding, clustering, etc.) on the plurality of points received from the LiDAR sensor 38 and output a first point cloud 90 (e.g., first plurality of points) corresponding to the calibration board 36 and a second point cloud 92 corresponding to the two-dimensional surface 16. In an embodiment, the controller 28 may determine a third point cloud 94 (e.g., third plurality of points) corresponding to the object 25 based on the data received from the LiDAR sensor 38. The first point cloud 90 may include a first plurality of three-dimensional coordinates corresponding to a first plurality of points disposed on an exterior surface of the calibration board 36 relative to the LiDAR sensor 38. The second point cloud 92 may include a second plurality of three-dimensional coordinates corresponding to a second plurality of points disposed on an exterior surface of the two-dimensional surface 16 relative to the LiDAR sensor 38. The third point cloud 94 may include a third plurality of three-dimensional coordinates corresponding to a third plurality of points disposed on an exterior surface of the object 25 relative to the LiDAR sensor 38.

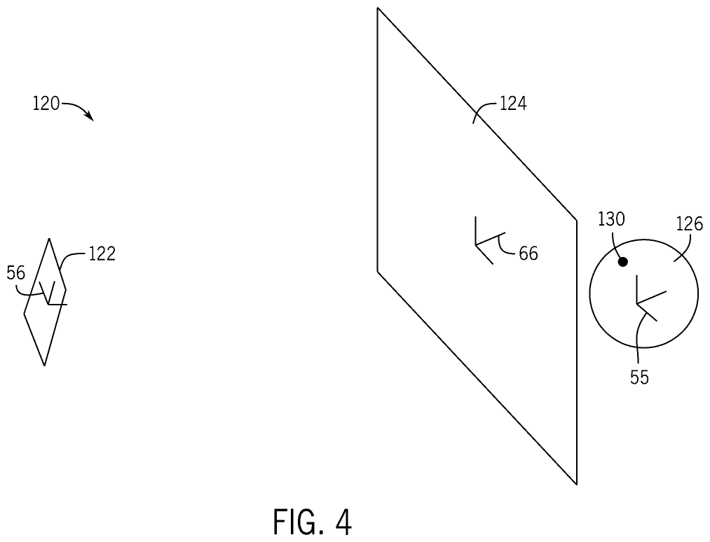

FIG. 4 is a diagram of a plurality of fitted geometries 120 determined by the calibration system 26 of FIG. 1 based on the data received from the LiDAR sensor. In the illustrated embodiment, the controller determines a first fitted plane 122 corresponding to the calibration board based on the first point cloud determined by the data received from the LiDAR sensor. The controller may also determine a second fitted plane 124 corresponding to the two-dimensional surface. The controller may determine the first fitted plane 122 and/or the second fitted plane 124 based on a least-squares algorithm. In an embodiment, the controller may fit a three-dimensional model 126 (e.g., computer-aided design model) of the object to the third point cloud. In the illustrated embodiment, the camera reference frame 56 is positioned at the center of the first fitted plane 122, and the surface reference frame 66 is positioned at the center of the second fitted plane 124. In an embodiment, the camera reference frame 56 may be located at an arbitrary location on the first fitted plane 122, and the surface reference frame 66 may be located at an arbitrary location on the second fitted plane 124.

The controller may determine a second transformation matrix (T_{w,b}) indicative of a second spatial (e.g., affine) transformation from the calibration board to the two-dimensional surface based on the first fitted plane 122 and the second fitted plane 124. That is, the second transformation matrix may be indicative of a pose of the two-dimensional surface relative to the calibration board. In an embodiment, the controller may determine the second transformation matrix using an algorithm (e.g., Kabsch algorithm, Kabsh-Umeyama algorithm) that determines an optimal rotation matrix between two sets of points. The second transformation matrix be of the following form, where R_{w,b} is a rotation matrix indicative of an orientation of the two-dimensional surface relative to the calibration board and t_{w,b} is indicative of a translation (e.g., position) of the two-dimensional surface relative to the calibration board:

$${T}_{w , b} = [ \begin{matrix}{R}_{w , b} & {t}_{w , b} \\ 0 & 1\end{matrix} ]$$

In an embodiment, the controller may determine a third transformation matrix (T_{o,w}) indicative of a third spatial (e.g., affine) transformation from the two-dimensional surface to the three-dimensional model 126. For example, as discussed herein, the three-dimensional model 126 may be registered based on the third point cloud received from the LiDAR sensor. The third transformation matrix be of the following form, where R_{o,w} is a rotation matrix indicative of an orientation of the object reference frame 55 relative to the surface reference frame 66 and t_{c,w} is indicative of a translation (e.g., position) of the object reference frame 55 relative to the surface reference frame 66:

$${T}_{o , w} = [ \begin{matrix}{R}_{o , w} & {t}_{o , w} \\ 0 & 1\end{matrix} ]$$

The controller may determine a rendering matrix (K_{w}) based on one or more properties of the camera. The rendering matrix may be a synthetic camera matrix that images from the calibrated center (e.g., origin) of the surface at which the camera pinhole has been placed to the image plane of the surface. The image plane to which the calibrated center is imaged may span the entire surface or, in an embodiment, a portion of the surface. In an embodiment, the one or more properties of the camera may include the focal point of the camera and/or an offset of the principal point of the camera. The rendering matrix may convert the three-dimensional image coordinate to a two-dimensional window coordinate.

The controller may determine a mapping matrix (M) based on an inverse of the camera intrinsic matrix (K_{c}⁻), the first transformation matrix (T_{b,c}), the second transformation matrix (T_{w,b}), the rendering matrix (K_{w}), or a combination thereof, based on the following equation:

$$M = [ \begin{matrix}{K}_{w} & 0 \\ 0 & 1\end{matrix} ] {T}_{w , b} {T}_{b , c} [ \begin{matrix}{K}_{c}^{-} & 0 \\ 0 & 1\end{matrix} ]$$

The mapping matrix may be used to convert the two-dimensional image coordinates output by the camera to two-dimensional coordinates relative to the surface reference frame 66. This conversion is shown in the follow equation:

$$[ \begin{matrix}{p}_{w} \\ 1\end{matrix} ] = M [ \begin{matrix}{p}^{′} \\ 1\end{matrix} ]$$

$${p}_{w} = [ \begin{matrix}s \\ t \\ 1\end{matrix} ]$$

In the above equation, p_{w} is the set of two-dimensional coordinates relative to the surface reference frame 66, where s is the first coordinate and t is the second coordinate.

In an embodiment, when projecting the two-dimensional image coordinates onto the object, the controller may determine the mapping matrix (M) based on an inverse of the camera intrinsic matrix (K_{c}⁻), the first transformation matrix (T_{b,c}), the second transformation matrix (T_{w,b}), the third transformation matrix (T_{o,w}), the rendering matrix (K_{w}), or a combination thereof, based on the following equation:

$$M = [ \begin{matrix}{K}_{w} & 0 \\ 0 & 1\end{matrix} ] {T}_{o , w} {T}_{w , b} {T}_{b , c} [ \begin{matrix}{K}_{c}^{-} & 0 \\ 0 & 1\end{matrix} ]$$

In an embodiment, the controller may use an algorithm (e.g., barrel distortion algorithm) and/or a look-up table to map the two-dimensional coordinates relative to the surface reference frame 66 to the three-dimensional model 126. The following equation is a general equation for this mapping:

$$[ \begin{matrix}{p}_{o} \\ 1\end{matrix} ] = f ( M [ \begin{matrix}{p}^{′} \\ 1\end{matrix} ] )$$

$${p}_{o} = [ \begin{matrix}a \\ b \\ 1\end{matrix} ]$$

In the above equation, po is the set of two-dimensional coordinates corresponding to a point 130 on the three-dimensional model 126, where a is the first coordinate and b is the second coordinate. The function ƒ is a nonlinear function (e.g., barrel distortion) that maps a point from a plane to a curved surfaced. Although the illustrated embodiment shows a single object 126, it may be recognized that the controller may map the two-dimensional coordinates relative to the surface reference frame 66 to two or more objects 126.

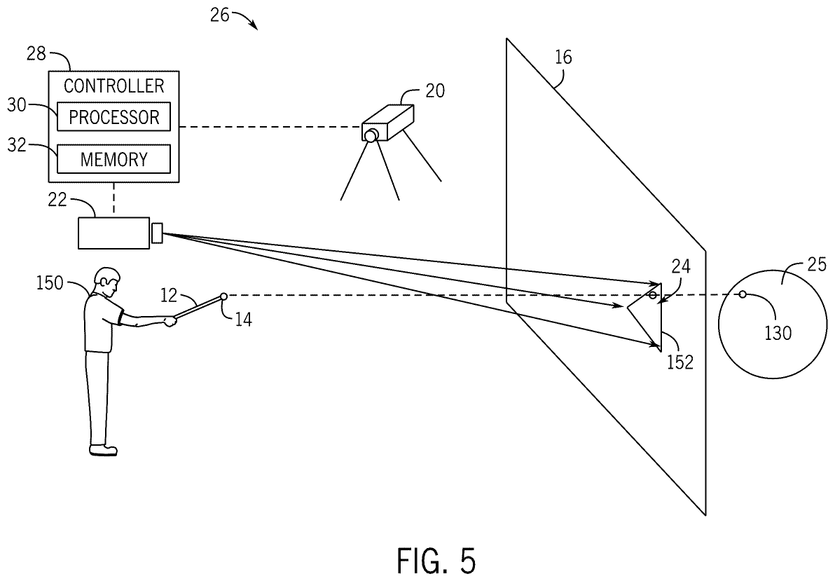

FIG. 5 is a diagram of a user 150 using the attraction system 10 based on a calibration via the calibration system 26 of FIG. 1. In the illustrated embodiment, the output device 22 (e.g., projector) and the camera 20 are communicatively coupled to the controller 28. As shown, the controller 28 instructs the output device 22 to project the image 24 onto the two-dimensional surface 16. In an embodiment, the output device 22 may project the image 24 onto the object 25. In certain embodiments, the two-dimensional surface 16 may be a window. Additionally or alternatively, the two-dimensional surface 16 may be removed (e.g., omitted) during operation of the attraction system 10.

In an embodiment, the controller 28 may determine a location of the reference marker 14 with respect to the camera 20 based on a signal received from the camera 20. It may be recognized that the reference marker 14 used during operation of the attraction system 10 may or may not be the same as the reference marker 14 used in the calibration procedure disclosed herein. The controller 28 may determine a mapping matrix that maps a camera coordinate to a surface coordinate with respect to the two-dimensional surface 16. The controller 28 may determine a corresponding location of the reference marker 14 on the two-dimensional surface 16 based on the location and the mapping matrix.

In an embodiment, the controller 28 may instruct the output device 22 to alter (e.g., change, move) the image 24 in response to the corresponding location of the reference marker 14 (e.g., with respect to the two-dimensional surface 16) intersecting the image 24. For example, the controller 28 may determine whether the corresponding location of the reference marker 14 is within a perimeter 152 of the image 24. In response to determining the corresponding location to be intersecting the image 24, the controller 28 may alter the image 24 by changing an appearance of the image 24. For example, the controller 28 may cause a change in shape of the image 24, a movement of the image 24, a change in color of the image 24, or a combination thereof. As shown, the corresponding location of the reference marker 14 on the two-dimensional surface 16 is horizontally aligned with the reference marker 14. That is, the mapping matrix aligns the reference marker 14 to a location on the two-dimensional surface 16 irrespective of the direction in which the handheld object 12 is pointed.

In the illustrated embodiment, the image 24 is projected onto the two-dimensional surface 16, and the controller 28 may alter the image 24 based on the corresponding location of the reference marker 14 with respect to the two-dimensional surface 16. In an embodiment, the output device 22 may project the image 24 onto the object 25. In response to a corresponding location of the reference marker 14 with respect to the object 25 intersecting the image 24, the output device 22 may change an appearance of the image 24 as it appears on the object 25.

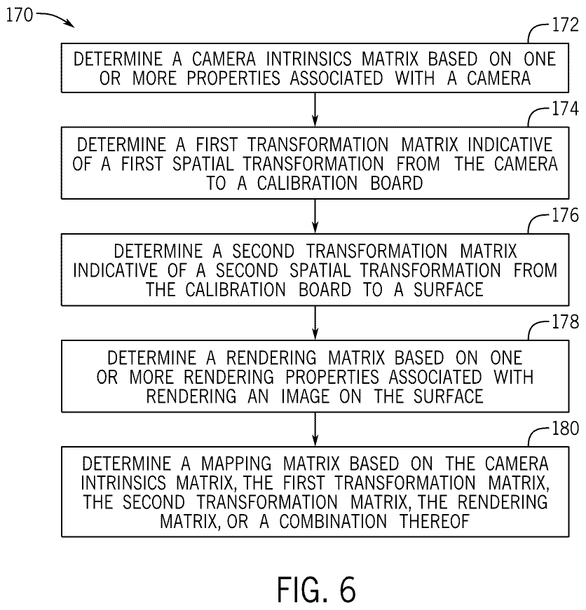

FIG. 6 is a flow diagram of an example method 170 performed by the calibration system of FIG. 1. The method 170 may be performed by a computing device or controller disclosed above with reference to FIG. 1 or any other suitable computing device(s) or controller(s). In an embodiment, the computing device may include one or more tangible, non-transitory, computer-readable media, having instructions that, when executed by at least one processor, cause the at least one processor to execute one or more blocks of the method 170. Furthermore, the blocks of the method 170 may be performed in the order disclosed herein or in any other suitable order. For example, certain blocks of the method 170 may be performed concurrently. In addition, in certain embodiments, at least one of the blocks of the method 170 may be omitted.

In block 172 of the method 170, the controller may determine a camera intrinsic matrix based on one or more properties associated with the camera. In an embodiment, the camera intrinsic matrix may be based on a focal length of the camera and/or an offset of a principal point of the camera.

In block 174 of the method 170, the controller may determine a first transformation matrix indicative of a first spatial (e.g., affine) transformation from the camera to the calibration board. In an embodiment, the first transformation matrix may be determined based on four or more correspondences 60 between the calibration board and the camera. As discussed herein, the four or more correspondences may include intersections on a checkerboard pattern, objects that have an appearance like that of the reference marker 14, or a combination thereof.

In block 176 of the method 170, the controller may determine a second transformation matrix indicative of a second spatial transformation from the calibration board to the two-dimensional surface. In an embodiment, the controller may receive data from the LiDAR sensor. The data may include a first point cloud corresponding to the calibration board and a second point cloud corresponding to the two-dimensional surface. In an embodiment, the data may also include a third point cloud corresponding to the object. The controller may fit a first plane to the first point cloud, and a second plane to the second point cloud. The controller may determine the second transformation matrix based on the first and second fitted planes. In an embodiment, the controller may fit a three-dimensional model to the third point cloud. The controller may determine a third transformation matrix indicative of a spatial transformation between the two-dimensional surface and the object.

In block 178 of the method 170, the controller may determine a rendering matrix based on one or more properties of the camera. For example, the one or more properties may include a focal length of the camera, a principal point of the camera, or a combination thereof. The rendering matrix may determine one or more aspects of how the reference marker is rendered on the two-dimensional surface.

In block 180 of the method 170, the controller may determine a mapping matrix based on the camera intrinsic matrix, the first transformation matrix, the second transformation matrix, the third transformation matrix, the rendering matrix, or a combination thereof. The mapping matrix may map a point (e.g., location) with respect to the camera (e.g., image coordinates) to a point (e.g., additional location) with respect to the two-dimensional surface (e.g., window coordinates). In an embodiment, the point with respect to the camera (e.g., in the reference frame of the camera) and/or the point with respect to the surface (e.g., in the reference frame of the surface) may be represented by two coordinates. That is, a point in a reference frame of the camera may be represented by two coordinates, and a point in a reference frame of the two-dimensional surface may be represented by two coordinates. In an embodiment, more than two coordinates may be used for representing the point in the camera reference frame, the surface reference frame, or a combination thereof.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. § 112 (f).

1. A system, comprising:
a reference marker;
a camera configured to provide a signal indicative of a position of the reference marker;
a surface; and
a controller comprising memory and a processor system including one or more processors, wherein the controller is configured to:
determine a camera intrinsics matrix based on one or more properties associated with the camera
determine a first transformation matrix indicative of a first spatial transformation from the camera to a calibration board;
determine a second transformation matrix indicative of a second spatial transformation from the calibration board to the surface;
determine a mapping matrix based on the camera intrinsics matrix, the first transformation matrix, the second transformation matrix, or a combination thereof; and
defining an alignment of a handheld device comprising the reference marker with the surface based on the mapping matrix.

2. The system of claim 1, wherein the controller is configured to:
determine a rendering matrix based on one or more properties of the camera; and
determine the mapping matrix based on the camera intrinsics matrix, the first transformation matrix, the second transformation matrix, the rendering matrix, or a combination thereof.

3. The system of claim 1, comprising a projector configured to project an image onto the surface, wherein the camera and the projector are communicatively coupled to the controller.

4. The system of claim 3, wherein the controller is configured to:
determine a location of the reference marker with respect to the camera based on a signal received from the camera;
determine a corresponding location of the reference marker on the surface based on the mapping matrix and the location; and
instruct the projector to alter the image in response to the corresponding location intersecting the image.

5. The system of claim 4, wherein the location comprises two coordinates.

6. The system of claim 1, wherein the controller is configured to determine the first transformation matrix based on four or more correspondences between the calibration board and the camera.

7. The system of claim 1, wherein the controller is configured to:
receive data from a light detection and ranging (LiDAR) sensor, wherein the data comprises:
a first plurality of points corresponding to the calibration board; and
a second plurality of points corresponding to the surface;
fit a first plane to the first plurality of points;
fit a second plane to the second plurality of points; and
determine the second transformation matrix based on the first and second planes.

8. The system of claim 7, wherein the data comprises a third plurality of points indicative of an object, wherein the controller is configured to:
fit a three-dimensional model of the object to the third plurality of points;
determine a third transformation matrix indicative of a third spatial transformation from the surface to the object based on the second plane and the three-dimensional model; and
determine the mapping matrix based on the camera intrinsics matrix, the first transformation matrix, the second transformation matrix, the third transformation matrix, or a combination thereof.

9. The system of claim 1, wherein the surface is at least partially outside of a field of view of the camera.

10. A method, comprising:
determining, via a processor, a location of a reference marker with respect to a camera based on a signal received from the camera;
determining, via the processor, a camera intrinsic matrix based on one or more properties associated with the camera;
determining, via the processor, a first transformation matrix indicative of a first spatial transformation from the camera to a calibration board based on the location;
determining, via the processor, a second transformation matrix indicative of a second spatial transformation from the calibration board to a surface; and
determining, via the processor, a mapping matrix based on the camera intrinsics matrix, the first transformation matrix, the second transformation matrix, or a combination thereof; and
defining, via the processor, an alignment of a handheld device comprising the reference marker with the surface based on the mapping matrix.

11. The method of claim 10, comprising:
determining, via the processor, a rendering matrix based on one or more properties of the camera; and
determining, via the processor, the mapping matrix based on the camera intrinsics matrix, the first transformation matrix, the second transformation matrix, the rendering matrix, or a combination thereof.

12. The method of claim 10, comprising:
determining, via the processor, a corresponding location of the reference marker on the surface based on the mapping matrix and the location; and
instructing, via the processor, a projector to alter an image projected onto the surface in response to the corresponding location intersecting the image.

13. The method of claim 12, wherein the location comprises two coordinates.

14. The method of claim 10, comprising determining, via the processor, the first transformation matrix based on four or more correspondences between the calibration board and the camera.

15. The method of claim 10, comprising:
receiving, via the processor, data from a light detection and ranging (LiDAR) sensor, wherein the data comprises:
a first plurality of points corresponding to the calibration board; and
a second plurality of points corresponding to the surface;
fitting, via the processor, a first plane to the first plurality of points;
fitting, via the processor, a second plane to the second plurality of points; and
determining, via the processor, the second transformation matrix based on the first plane and the second plane.

16. The method of claim 15, wherein the data comprises a third plurality of points, the method further comprising:
fitting, via the processor, a three-dimensional model of an object to the third plurality of points;
determining, via the processor, a third transformation matrix indicative of a third spatial transformation from the surface to the object based on the second plane and the three-dimensional model; and
determining, via the processor, the mapping matrix based on the camera intrinsics matrix, the first transformation matrix, the second transformation matrix, the third transformation matrix, or a combination thereof.

17. One or more tangible, non-transitory, computer-readable media, comprising instructions that, when executed by at least one processor, cause the at least one processor to:
determine a location of a reference marker with respect to a camera based on a signal received from the camera;
determine a camera intrinsics matrix based on one or more properties associated with the camera;
determine a first transformation matrix indicative of a first spatial transformation from the camera to a calibration board;
determine a second transformation matrix indicative of a second spatial transformation from the calibration board to a surface;
determine a mapping matrix based on the camera intrinsics matrix, the first transformation matrix, the second transformation matrix, or a combination thereof; and
define an alignment of a handheld device comprising the reference marker with the surface based on the mapping matrix.

18. The one or more tangible, non-transitory, computer-readable media of claim 17, wherein the instructions cause the at least one processor to:
determine a rendering matrix based on one or more rendering properties associated with rendering an image on the surface; and
determine the mapping matrix based on the camera intrinsics matrix, the first transformation matrix, the second transformation matrix, the rendering matrix, or a combination thereof.

19. The one or more tangible, non-transitory, computer-readable media of claim 17, wherein the instructions cause the at least one processor to instruct a projector to project an image onto the surface based on the mapping matrix mapping a camera coordinate associated with the camera to a surface coordinate associated with the surface.

20. The one or more tangible, non-transitory, computer-readable media of claim 17, wherein the instructions cause the at least one processor to determine the first transformation matrix based on four or more correspondences between the calibration board and the camera.
